(19) United States
(12) Patent Application Publication
(10) Pub. No.: US 2011/0186083 A1
(43) Pub. Date: Aug. 4, 2011

(54) PHARMACEUTICAL CELL CLEANING PROCESS

(75) Inventors: Steven Cook, Vega, TX (US); Pierce Pillon, Amarillo, TX (US); Kevin Pawlowski, Amarillo, TX (US); Richard M. Hoffman, Bolton, MA (US); Terry Munson, Kokomo, IN (US)

(73) Assignee: ILLINOIS TOOL WORKS INC., Glenview, IL (US)

(21) Appl. No.: 12/700,019

(22) Filed: Feb. 4, 2010

(51) Int. Cl. B08B 3/08

(52) U.S. Cl. 134/22.18

(57) ABSTRACT

A method of cleaning a pharmaceutical cell that can be carried out onsite in a pharmacy. In particular, the method can be used to clean a pharmaceutical super cell. The method includes placing the cell in a resealable container; adding a wash solution to the resealable container; sealing the resealable container; shaking the sealed container; pouring the wash solution out of the resealable container; and rinsing the cell by repeating the preceding steps using a rinse solution in place of the wash solution. The wash solution may include soap, alcohol, and/or a surfactant. The rinse solution may include deionized water and/or isopropyl alcohol, for example.

### FIELD OF THE INVENTION

The present invention relates generally to a process for cleaning a pill dispensing system.

### BACKGROUND OF THE INVENTION

Pharmaceutical cells are boxes that hold and release pills. These cells are typically made of plastic and used with robotic pill dispensing equipment in pharmacies. Cells come in various sizes, the largest of which is called a “super cell.”

Pharmacists may use a single cell for the distribution of many different types of pills. Cells must be cleaned between use with different types of pills in order to prevent cross-contamination resulting from the dust or other residue that is inevitably left behind by the pills. Even cells that are used for a single type of pill must be cleaned periodically for routine maintenance.

One technique currently used to clean these cells is to blow out the dust with a duster. This technique creates the obvious hazard of potentially contaminating any surface within the vicinity of the dust that is blown from the cell.

In many instances, cells are sent back to the manufacturer or supplier for thorough cleaning to remove drug residue. This centralized cleaning procedure may be performed using isopropyl alcohol batch cleaning, or using large-scale ultrasonic cleaning devices. In either case, this procedure is quite costly, considering shipping costs as well as the need to provide replacement cells once the dirty cells have been removed from the pharmacy. This procedure is also time-consuming and requires a considerable amount of logistics planning.

In other instances, a pharmacy may purchase a small ultrasonic cleaner in order for the pharmacists to clean the cells themselves. However, even small ultrasonic cleaners take up space and are relatively expensive.

There is thus a need or desire for a method of cleaning pharmaceutical cells onsite at a pharmacy. There is a further need or desire for such a method that does not require expensive or space-consuming equipment.

### SUMMARY OF THE INVENTION

A method in accordance with the principles of the invention provides a way to clean a pharmaceutical cell onsite in a pharmacy without requiring expensive or space-consuming equipment. The method can be used to clean virtually any size pharmaceutical cell, including the largest type of cell, namely super cells.

The method suitably includes the steps of placing the cell in a resealable container, adding a wash solution to the resealable container, sealing the resealable container, shaking the sealed container, pouring the wash solution out of the resealable container, and rinsing the cell by repeating the preceding steps using a rinse solution in place of the wash solution. The wash solution can include soap, alcohol, and/or a surfactant. For example, the wash solution may include deionized water and a polyglucoside. As another example, the wash solution may include deionized water and alcohol ethoxylate.

Certain embodiments of the present invention provide compliance with strict local disposal laws by ensuring that the wash solution is in a neutral pH range, which may be drained in an ordinary sink. Additionally, the rinse solution may also be formulated to be in a neutral pH range for the same reason.

The rinsing step may be performed just once or multiple times using one or more rinse solutions. For example, the cell may be rinsed a first time with a first rinse solution and subsequently rinsed a second time with a second rinse solution. Alternatively, the cell may be rinsed a first time with a first rinse solution and subsequently rinsed a second time using the same type of solution. One example of a suitable rinse solution includes deionized water. Another example of a suitable rinse solution includes isopropyl alcohol.

The method can be carried out relatively quickly, such as in less than 10 minutes. Additionally, the method can be carried out at room temperature. Thus, the method can be carried out with minimal expense, minimal space, and with minimal effort.

This invention will become more fully understood from the following detailed description, taken in conjunction with the accompanying drawings described herein below, and wherein like reference numerals refer to like parts.

### BRIEF DESCRIPTION OF THE DRAWINGS

FIG. 1 illustrates a front perspective view of a pharmaceutical super cell.

FIG. 2 illustrates a pharmaceutical super cell inside a resealable container.

FIG. 3 illustrates a pharmaceutical super cell immersed in a wash solution inside a resealable container.

FIG. 4 illustrates a bottom perspective view of another pharmaceutical super cell.

FIG. 5 illustrates a side perspective view of the pharmaceutical super cell in FIG. 4.

FIG. 6 illustrates a front perspective view of the pharmaceutical super cell in FIGS. 4 and 5.

FIG. 7 illustrates a diagram of a test cell for analyzing the thoroughness of a cleaning method according to an embodiment of the present invention.

FIG. 8 illustrates a testing device for electrical testing to analyze the thoroughness of a cleaning method according to an embodiment of the present invention.

### DESCRIPTION OF PREFERRED EMBODIMENTS

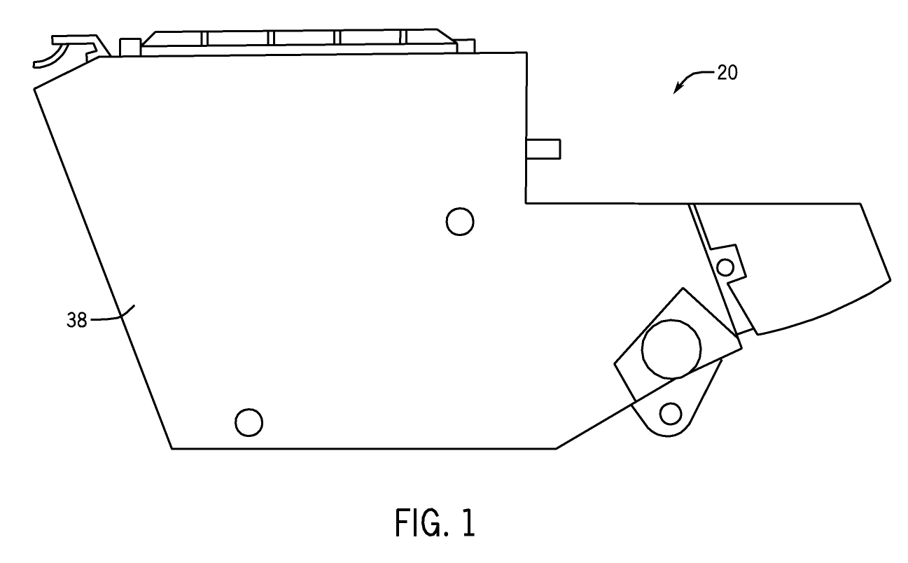

FIG. 1 illustrates a front perspective view of a pharmaceutical super cell 20. The super cell 20 is part of a pill dispenser used in pharmacies to hold and release pills. The super cell is the largest size cell used with a pill dispenser. Methods of cleaning pharmaceutical pill dispensing equipment in accordance with the claimed invention are intended to remove the water-soluble pill residue from inside cells 20 without the use of any expensive equipment or machinery. Thus, the methods described herein can be carried out onsite in a pharmacy. Furthermore, the methods described herein can be applied to any size pharmaceutical cell, from the smallest cells to the super cells.

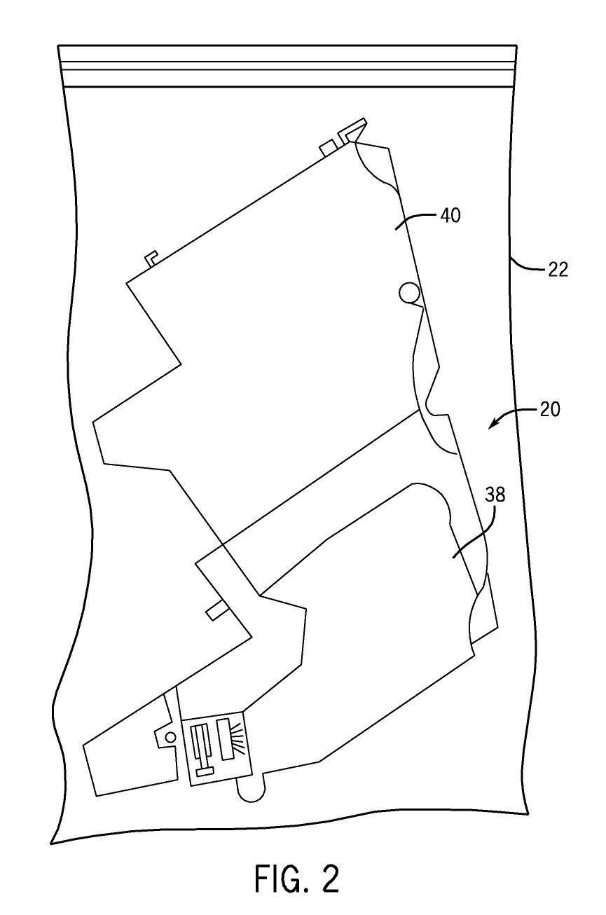

In one embodiment of the invention, the cell 20 is first placed in a resealable container 22, as shown in FIG. 2. Examples of suitable resealable containers 22 include resealable flexible bags, such as those available from Kapak Corporation of Minneapolis, Minn., or resealable plastic bowls, buckets, or other containers, also available from Kapak Corporation or various other suppliers. The resealable container 22 may either be disposable or durable. As used herein, the term “disposable” refers to containers that are typically sufficient for 1-5 uses, and the term “durable” refers to containers that should last for more than 5 uses.

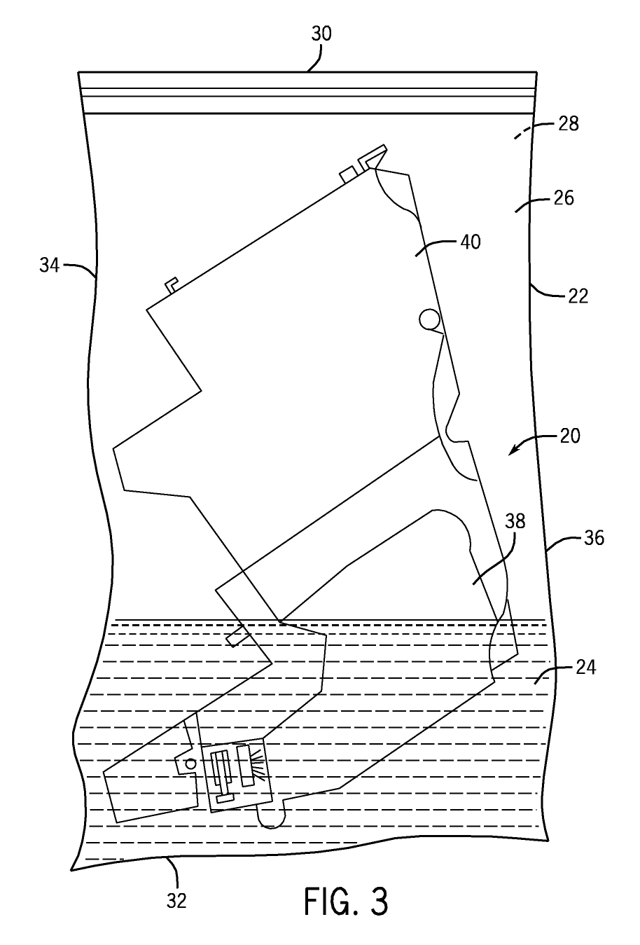

A wash solution 24 can then be added to the resealable container 22, as shown in FIG. 3, and the container 22 may then be sealed. For instance, the wash solution 24 may be poured into the cell 20 within the resealable container 22, and the container 22 may then be sealed. The amount of wash solution 24 is dependent on the size of the cell 20 as well as the size of the resealable container 22. For a super cell, for example, approximately 1 liter of the wash solution is an appropriate amount. As can be seen in FIG. 3, the amount of wash solution 24 should be large enough for at least a portion of the cell 20 to be submerged in the solution 24, yet the wash solution 24 should fill less than half the resealable container 22 in order to allow enough empty space within the container 22 for proper agitation to occur, as described in greater detail below. In general, the amount of wash solution 24 used may be approximately 5% to 50% of the volume of the resealable container 22, or about 10% to about 40% of the volume of the resealable container 22.

The wash solution 24 may be a soapy water solution, or alcohol water, or other surfactant, for example. As one example, the wash solution 24 may include deionized water and a polyglucoside, such as GLUCOPON®, available from Cognis of Ambler, Pa. As another example, the wash solution 24 may include 1 liter of deionized water and 100 ul of Huntsman SURFONIC® L12-6 surfactant (alcohol ethoxylate), available from Huntsman International LLC of The Woodlands, Tex. In general, the wash solution 24 may include at least 90%, or at least 95%, or at least 99% by volume deionized water and the remainder may be soap, alcohol, and/or other surfactant.

Once the wash solution 24 has been poured into the resealable container 22 and the container 22 has been sealed, the wash solution 24 within the container 22 may be allowed to set for a short period of time, such as about 30 seconds or less. The sealed container can then be shaken. The sealed container 22 can be shaken on all six orientations, namely concentrating forces on the front 26, back 28, top 30, bottom 32, left side 34, and right side 36 of the container 22. Shaking the sealed container 22 in this manner provides agitation that may be necessary to remove any pill residue from holes or crevices within the cell 20. The shaking can be carried out for a minimum of 2 minutes, for example. After sufficiently shaking the sealed container 22, the container 22 can then be opened and the wash solution 24 poured out of the container 22 while maintaining the cell 20 within the container 22.

The cell 20 can then be rinsed in much the same manner as described with respect to the wash solution 24, but using a rinse solution in place of the wash solution 24. In particular, the rinse solution can be poured into the cell 20 within the resealable container 22, and the container 22 can then be sealed. The sealed container 22 may be allowed to set for a short time, such as about 30 seconds or less. The sealed container 22 may then be shaken on all six orientations, suitably for a minimum of 2 minutes. After shaking the sealed container 22, the container 22 can then be opened and the rinse solution poured out of the container 22 while maintaining the cell 20 within the container 22.

The amount of rinse solution used in each rinse cycle may be about the same amount as the wash solution 24. Alternatively, the amount of rinse solution may be considerably greater than the amount of wash solution 24 used. For example, when using 1 liter of wash solution, a rinse cycle may subsequently be performed using approximately 2 liters of rinse solution. One example of a suitable rinse solution is deionized water.

Multiple rinse cycles may be performed using either the same type of rinse solution or different rinse solutions each time. For example, a first rinse cycle may be performed using deionized water as the first rinse solution and a second rinse cycle may be performed using isopropyl alcohol as the second rinse solution. In particular, isopropyl alcohol can be sprayed and/or flushed through the cell 20 to rinse the cell 20 as well as to scavenge any moisture from the cell 20. The amount of rinse solutions may also vary between rinse cycles. For instance, when using deionized water as the first rinse solution and isopropyl alcohol as the second rinse solution, a much greater amount of the first rinse solution may be used compared to the amount of the second rinse solution.

After each rinse cycle, the cell 20 should be examined for any caked residue remaining in the cell 20. If there is any remaining residue, another rinse cycle should be performed. Prior to reconnecting the cell 20 with the rest of the pill dispenser, the cell 20 should be free of moisture and caked residue.

Local disposal laws vary from place to place. Some local regulations may allow for dumping the soluble waste within the wash solution and rinse solution down a drain, particularly since the amount of pill dust should be negligible; however, some communities may not allow such draining. In certain situations, the wash solution 24 and/or the rinse solution may be formulated to be in a neutral pH range to accommodate local disposal laws. Alternatively, the wash solution 24 and/or the rinse solution may be poured into a medical waste container when drained from the resealable container 22 if the solution may not be poured down the drain. In any case, wash solutions and rinse solutions should not be reused to clean subsequent cells 20.

As illustrated in FIG. 1, the methods described herein may be applied to just a dispenser portion 38 of the cell 20; alternatively, the methods may be applied to the dispenser portion 38 as well as any additional containment compartments 40 of the cell 20, such as those illustrated in FIGS. 2 and 3.

The entire method may be carried out at room temperature. Additionally, all materials used in the method may be stored at room temperature. For the cleaning of most cells 20, the method can be carried out in less than 10 minutes. Thus, the invention provides methods that can be carried out with minimal expense, minimal space, and with minimal effort.

### EXAMPLES

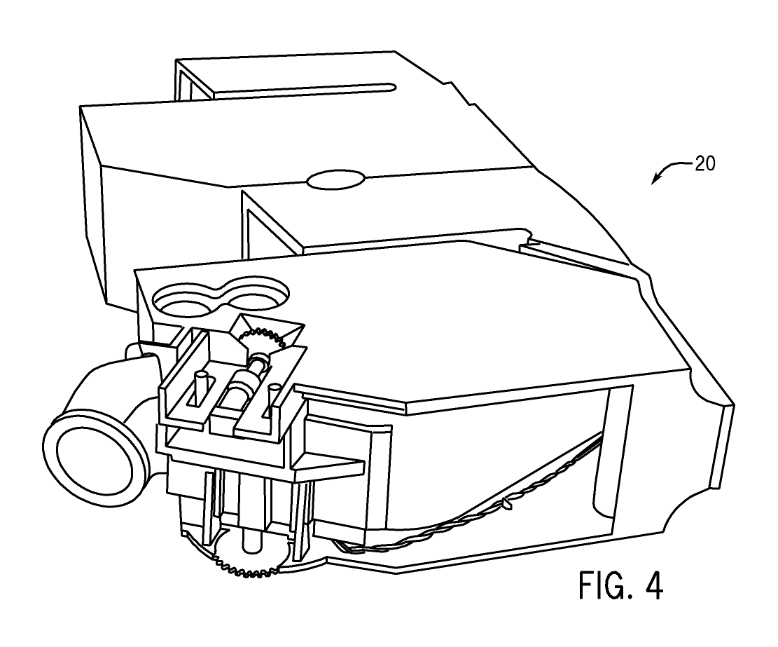

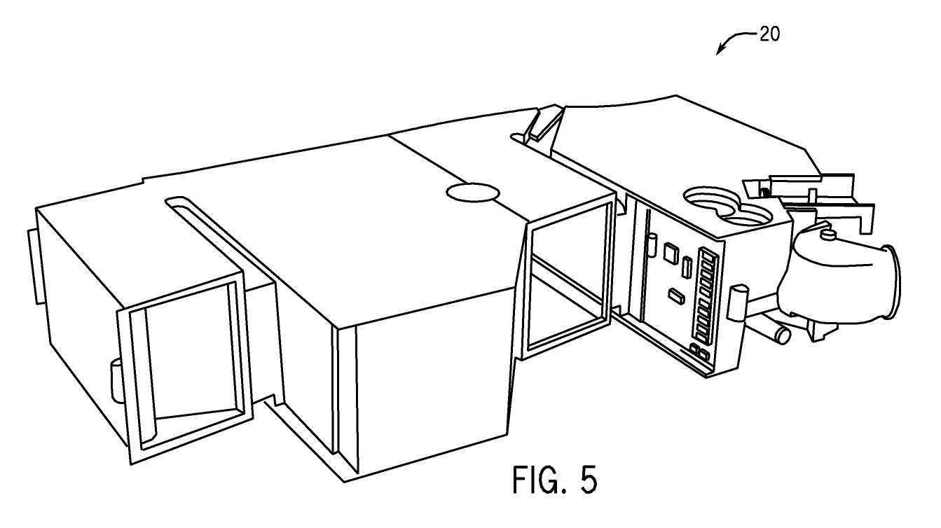

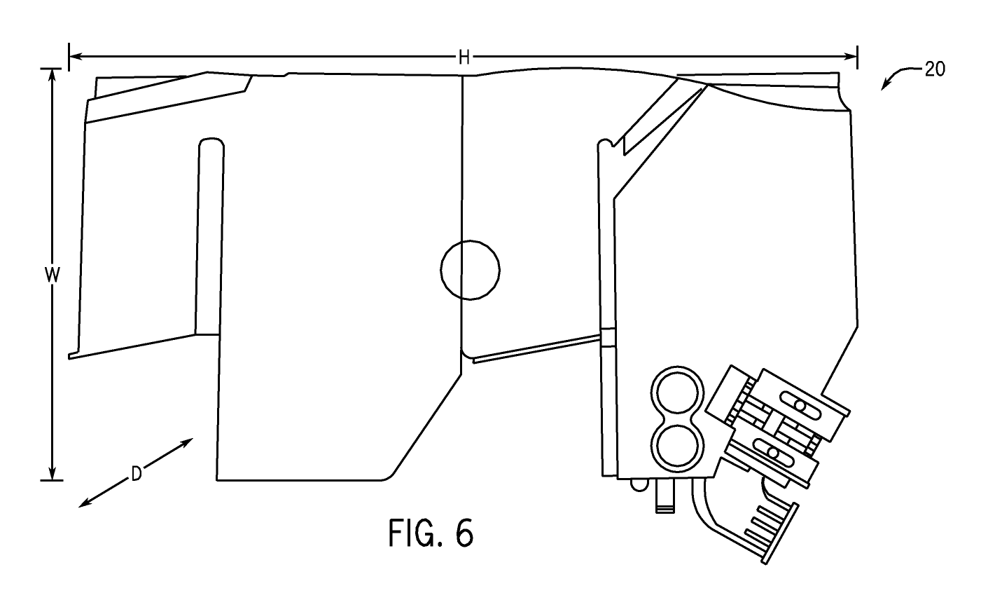

The above-described cleaning method was carried out on dirty PARATA® F5021369 super cells, available from Parata Systems of Durham, N.C., and the super cells, wash solutions, and rinse solutions were analyzed to determine the effectiveness of the cleaning method. This particular type of cell 20 is illustrated in FIGS. 4-6. As shown in FIG. 6, the cell 20 has a height (H) of approximately 13.5 inches, a width (W) of approximately 7 inches, and a depth (D) of approximately 2.75 inches.

Each cell 20 was placed in a PN 508 (12-inch by 16-inch) heat-sealable plastic bag made by Kapak Corporation. Next, 1 liter of wash solution (either 90% by volume deionized (DI) water combined with 10% by volume isopropyl alcohol (IPA), or deionized (DI) water with 100 ul of Huntsman SURFONIC® L12-6 surfactant (L12-6)) was poured into the bag and down into the super cell 20. The bag was then sealed and the wash solution, at room temperature, was allowed to set within the sealed bag for 30 seconds. The sealed bag was then shaken on all six orientations for 3 minutes total time in the bag (30 seconds of setting, 2.5 minutes of shaking). At the end of 3 minutes, the bag was opened and the wash solution was poured into a medical waste container while keeping the cell 20 in the bag. Samples of this wash solution were then analyzed as described below, with results appearing as ID #7 and 8 in Table 1 below.

A first rinse solution (2 liters of DI water only) was poured into the super cell 20 within the bag. The bag was then sealed and the first rinse solution, at room temperature, was allowed to set within the sealed bag for 30 seconds. The sealed bag was then shaken for a minimum of 2 minutes on all six orientations. Following the shaking, the bag was opened and the first rinse solution poured into a medical waste container. Samples of this first rinse solution were then analyzed with results appearing as ID #9 and 10 in Table 1 below.

A second rinse solution (2 liters of DI water only) was poured into the super cell 20 within the bag. The bag was then sealed and the second rinse solution, at room temperature, was allowed to set within the sealed bag for 30 seconds. The sealed bag was then shaken for a minimum of 2 minutes on all six orientations. Following the shaking, the bag was opened and the second rinse solution poured into a medical waste container. Samples of this second rinse solution were then analyzed with results appearing as ID #11 and 12 in Table 1 below.

The super cell 20 was then removed from the bag and allowed to air dry on a towel or drying rack.

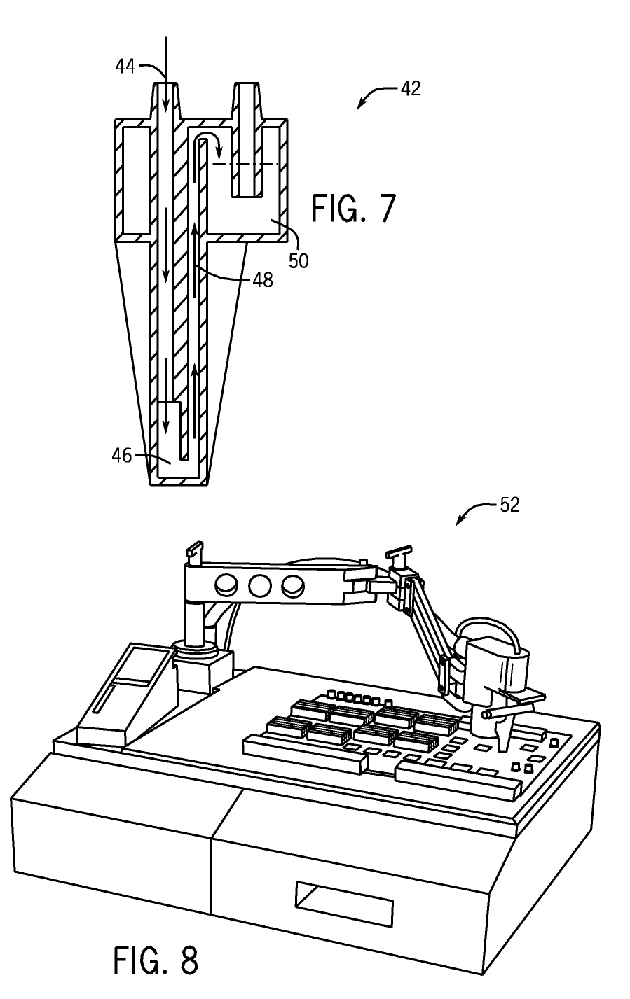

East test site used a fresh C3 test cell 42, such as the one illustrated in FIG. 7, to test and analyze the residue extracted from the identified site. In particular, the C3 test cell 42 has a heated extraction solution inlet 44 that leads to an extraction chamber 46; from the extraction chamber 46, an aspiration pathway of solution 48 leads to a collection cell 50 in which the solution is collected. Each extraction ran for 3 minutes, collecting 2.5 mL of extract solution. The C3 test time was an additional 3 minutes. The solution was transferred to test vials to be placed into an autosampler that injects the solution into the Ion Chromatograph for ionic analysis. The evaluation was carried out using a Dionex ICS 2000 system with an AS4A-SC column per IPC-TM-650, method 2.3.28. A 1.5 mL sample of each test sample's extract solution was analyzed using a 1.7 mM sodium bicarbonate/1.8 mM sodium carbonate eluent.

In order to assess the amount and composition of residue before and after cleaning (ID #1-6 and 13-19), the C3 test cell extraction solution has been designed to achieve effective ionic residue removal using a heated delivery system consisting of 3 stages:

1. Solution heating/delivery to the extraction site
2. Soak and ionization time
3. Aspiration of solution to a collection cell

This cycle is repeated 9 times to effectively remove the surface residues from a 0.1 square-inch area, generating approximately 2.5 mL of extraction solution to be used during the testing and afterwards for additional testing.

Electrical testing was then performed on the samples using a C3 test system 52, manufactured by Foresite Inc., as illustrated in FIG. 8. Using a sacrificial Y-pattern electrode immersed in the extraction solution, a 10-volt bias (+/−0.1V) was then applied to the electrode and an internal timer was started to measure the time it took to achieve a leakage event. The system measured the leakage across the electrode generated by the extraction solution plus the residues extracted from the board surface. A threshold of 500 uA was set to identify when a current leakage event had occurred. This threshold had been set using a combination of SIR and Ion Chromatography data. The electrical measurement was determined by assessing the time it took for the extraction solution and the 10-volt biased electrode to reach a 500 uA event. The system works under the theory that the more corrosive/conductive the residue, the faster it will take to achieve this event. The less corrosive or conductive the residue, the longer it will take to achieve. It was found that C3 timing results to achieve the 500 uA event in less than 120 seconds correlates to corrosive residues identified as “dirty.” Timing events that took longer than 60 seconds were correlated to cleaner, less corrosive residues and were identified as “clean.” Results are provided in Table 1.

TABLE 1
Super Cell Cleaning Results

| all values are in ug/in² | | | | | | | | | | |
|---|---|---|---|---|---|---|---|---|---|---|
| unless noted | | Ion Chromatography | | | | | | | C3 Tester | |
| | Sample | | | | | | | | | Time |
| ID# | Description | Cl⁻ | Na⁺ | Br⁻ | NO₃⁻ | PO₄²⁻ | SO₄²⁻ | CA⁺⁺ | Results | (sec) |

| | | | | | | | | | |
|---|---|---|---|---|---|---|---|---|---|
| recommended limits for | 1.0 | 1.0 | 1.0 | 1.0 | 1.0 | 1.0 | 1.0 | clean | >120 |
| “clean” | | | | | | | | | |

Cleaning with DI/IPA (90%/10%)

| | | | | | | | | | | |
|---|---|---|---|---|---|---|---|---|---|---|
| 1 | before clean A | 4.89 | 4.58 | 0 | 0 | 5.98 | 0.97 | 0 | dirty | 42 |
| 2 | before clean B | 2.44 | 1.78 | 0 | 0 | 30.24 | 1.79 | 0 | dirty | 33 |
| 3 | Post clean A | 0.11 | 0 | 0 | 0 | 0.14 | 0 | 0 | clean | 180 |
| 4 | Post clean B | 0.07 | 0 | 0 | 0 | 0.08 | 0 | 0 | clean | 180 |

Cleaning with DI water L12-6 in wash with 2 bag rinses

| | | | | | | | | | | |
|---|---|---|---|---|---|---|---|---|---|---|
| 5 | before clean | 8.19 | 0 | 0 | 0.58 | 0 | 1.55 | 0 | dirty | 41 |
| | (bag 1) | | | | | | | | | |
| 6 | before clean | 0.21 | 0 | 0 | 0.17 | 31.45 | 0.36 | 0 | dirty | 20 |
| | (bag 2) | | | | | | | | | |

Solutions after cleaning

| 7 | wash solution | 18.63 | 0 | 0.03 | 0.08 | 8.80 | 2.25 | 0 | not tested | |
|---|---|---|---|---|---|---|---|---|---|---|
| | bag 1 (L12-6) | | | | | | | | | |
| 8 | wash solution | 0.44 | 0 | 0.04 | 0.06 | 45.65 | 2.16 | 0 | not tested | |
| | bag 2 (L12-6) | | | | | | | | | |
| 9 | l^{st} rinse bag 1 | 0.41 | 0 | 0.01 | 0.01 | 0.05 | 0.01 | 0 | not tested | |
| | (DI water only) | | | | | | | | | |
| 10 | l^{st} rinse bag 2 | 0.33 | 0 | 0.01 | 0.01 | 2.79 | 0.03 | 0 | not tested | |
| | (DI water only) | | | | | | | | | |
| 11 | 2^{nd} rinse bag 1 | 0.08 | 0 | 0 | 0 | 0 | 0 | 0 | not tested | |
| | (DI water only) | | | | | | | | | |
| 12 | 2^{nd} rinse bag 2 | 0 | 0 | 0 | 0 | 0.05 | 0 | 0 | not tested | |
| | (DI water only) | | | | | | | | | |
| 13 | after clean | 0.04 | 0 | 0 | 0 | 0 | 0 | 0 | clean | 180 |
| | (bag 1) | | | | | | | | | |
| 14 | after clean | 0.00 | 0 | 0 | 0 | 0.02 | 0 | 0 | clean | 180 |
| | (bag 2) | | | | | | | | | |

Cleaning with DI water L12-6 in wash with 2 bag rinses

| | | | | | | | | | | |
|---|---|---|---|---|---|---|---|---|---|---|
| 15 | Post clean C | 0.04 | 0 | 0 | 0 | 0 | 0 | 0 | clean | 180 |
| 16 | Post clean D | 0.04 | 0 | 0 | 0 | 0.19 | 0 | 0 | clean | 180 |
| 17 | Post clean E | 0.05 | 0 | 0 | 0 | 0.04 | 0 | 0 | clean | 180 |
| 18 | Post clean F | 0.01 | 0 | 0 | 0 | 0 | 0 | 0 | clean | 180 |
| 19 | Post clean G | 0 | 0 | 0 | 0 | 0.11 | 0 | 0 | clean | 180 |

As shown by the data in Table 1, the methods described herein are capable of greatly reducing, if not completely removing, ionic residues associated with pill residue.

It should be understood that the invention is not limited in its application to the details of the method set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features or steps mentioned or evident from the text and/or the drawings. All of these different combinations constitute various alternative aspects of the present invention. The embodiments described herein explain the best modes known for practicing the invention and will enable others skilled in the art to utilize the invention.

What is claimed is:

1. A method of cleaning a pharmaceutical cell, comprising:
placing the cell in a resealable container;
adding a wash solution to the resealable container;
sealing the resealable container;
shaking the sealed container;
pouring the wash solution out of the resealable container; and
rinsing the cell by repeating the above steps using a rinse solution in place of the wash solution.

2. The method of claim 1, wherein the wash solution comprises at least one of the group consisting of soap, alcohol, and a surfactant.

3. The method of claim 1, wherein the wash solution comprises deionized water and a polyglucoside.

4. The method of claim 1, wherein the wash solution comprises deionized water and alcohol ethoxylate.

5. The method of claim 1, wherein the wash solution is in a neutral pH range.

6. The method of claim 1, comprising rinsing the cell two or more times using the rinse solution in place of the wash solution.

7. The method of claim 1, comprising rinsing the cell a first time with a first rinse solution and subsequently rinsing the cell a second time with a second rinse solution.

8. The method of claim 1, wherein the rinse solution comprises deionized water.

9. The method of claim 1, wherein the rinse solution comprises isopropyl alcohol.

10. The method of claim 1, wherein the rinse solution is in a neutral pH range.

11. The method of claim 1, wherein the method is carried out onsite in a pharmacy.

12. The method of claim 1, wherein the method is carried out at room temperature.

13. The method of claim 1, wherein the method is carried out in less than 10 minutes.

14. The method of claim 1, wherein the pharmaceutical cell is a super cell.

15. A method of cleaning a pharmaceutical super cell onsite in a pharmacy, comprising:
placing the super cell in a resealable container;
adding a wash solution to the resealable container, wherein the wash solution comprises at least one of the group consisting of soap, alcohol, and a surfactant;
sealing the resealable container;
shaking the sealed container;
pouring the wash solution out of the resealable container; and
rinsing the super cell by repeating the above steps using a rinse solution in place of the wash solution, wherein the rinse solution comprises at least one of the group consisting of deionized water and isopropyl alcohol.

16. The method of claim 15, wherein the wash solution comprises deionized water and a polyglucoside.

17. The method of claim 15, wherein the wash solution comprises deionized water and alcohol ethoxylate.

18. The method of claim 15, comprising rinsing the super cell two or more times using the rinse solution in place of the wash solution.

19. The method of claim 15, comprising rinsing the super cell a first time with a first rinse solution comprising deionized water and subsequently rinsing the super cell a second time with a second rinse solution comprising isopropyl alcohol.
